(19) United States
(12) Patent Application Publication
(10) Pub. No.: US 2004/0006469 A1
(43) Pub. Date: Jan. 8, 2004

(54) Apparatus and method for updating lexicon

(75) Inventor: Hyun-Seok Kang, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/457,472

(22) Filed: Jun. 10, 2003

(30) Foreign Application Priority Data
Jun. 28, 2002 (KR) 2002-36852

(51) Int. Cl. G10L 15/04

(52) U.S. Cl. 704/254

(57) ABSTRACT

An apparatus and method for updating a lexicon used in the field of voice recognition or voice synthesis are provided. The apparatus includes a multi-phonetic string generator which receives a word in the form of text data and generates phonetic strings corresponding to the word; a phonetic word converter, which receives the phonetic strings and converts them into respective phonetic words; and a multi-phonetic string selector, which receives the phonetic words from the phonetic word converter, determines what user option has been set, provides at least one phonetic word to a user, when a user option of providing at least one phonetic word has been set, receives a selection signal for selecting a phonetic word from the user, converts the selected phonetic word into a phonetic string, and outputs the phonetic string to the lexicon.

### CROSS-REFERENCE TO RELATED APPLICATIONS

This application claims the priority of Korean Patent Application No. 2002-36852, filed on Jun. 28, 2002, which is incorporated herein in its entirety by reference.

### BACKGROUND OF THE INVENTION

1. Field of the Invention

The present invention relates to an apparatus and method for updating a lexicon used for voice recognition or voice synthesis, and more particularly, to an apparatus and method for updating a lexicon, through which a user is allowed to select a phonetic string to be stored in the lexicon, thereby preventing unnecessary phonetic strings from being generated and generating phonetic strings, which are difficult to be automatically generated.

2. Description of the Related Art

Voice recognition apparatuses can be divided into fixed vocabulary voice recognition apparatuses and variable vocabulary voice recognition apparatuses. A fixed vocabulary voice recognition apparatus records a word to be recognized by a voice in advance and determines whether a word input in voice through a microphone coincides with the word recorded in advance. On the other hand, a variable vocabulary voice recognition apparatus receives text data corresponding to a word instead of recording a voice of the word, automatically generates a plurality of phonetic strings corresponding to the input word according to a predetermined phonetic string generation rule, and stores the input word and the correspondingly generated plurality of phonetic strings in a lexicon. Thereafter, if a voice is input through a microphone, a variable vocabulary voice recognition apparatus recognizes the input voice referring to the phonetic strings stored in the lexicon.

Accordingly, a variable vocabulary voice recognition apparatus must include a lexicon storing a word to be recognized for voice recognition and a plurality of phonetic strings corresponding to the word. In addition, when a new word to be recognized is added, the lexicon must be updated by storing the new word and a plurality of phonetic strings automatically generated corresponding to the new word according to the predetermined phonetic string generation rule. Such a lexicon is used in the field of voice synthesis such as text-to-speech (TTS) as well as voice recognition.

In a conventional variable vocabulary voice recognition apparatus, as many phonetic strings as possible corresponding to an input word are automatically generated according to a predetermined phonetic string generation rule and stored in a lexicon, and phonetic strings that are not defined by the phonetic string generation rule are not generated.

However, people have different pronunciation habits, and it is very difficult to regularize every phonetic variation and generate every possible phonetic string. In particular, it is more difficult to generate phonetic strings corresponding to a word of a foreign origin, such as a Chinese word. For example, in case of a Korean word “ [symbol] ”, when the word means “private”, it is pronounced as [Sad [symbol] \hat{ } k] while it is pronounced as [saz\hat{ } k] when it means a historical site. In order to automatically generate phonetic strings corresponding to such a Chinese word, morpheme analysis and semantic analysis must be performed. However, these two processes require a large amount of system resources, so it is unreasonable to adopt these processes into a lexicon used in a voice recognition apparatus.

Accordingly, such a conventional variable vocabulary voice recognition or voice synthesis apparatus generates unnecessary phonetic strings and stores them in a lexicon, thereby wasting system resources and slowing recognition speed. In addition, when a phonetic string is not defined by a predetermined phonetic string generation rule, the phonetic string is not generated at all.

### SUMMARY OF THE INVENTION

The present invention provides an apparatus and method for updating a lexicon, through which a user is allowed to select or input a phonetic string to be stored in the lexicon.

According to an aspect of the present invention, there is provided an apparatus for updating a lexicon. The apparatus includes a multi-phonetic string generator, which receives a word in the form of text data and generates a plurality of phonetic strings corresponding to the word; a phonetic word converter, which receives the plurality of phonetic strings and converts them into phonetic words, respectively; and a multi-phonetic string selector, which receives the phonetic words from the phonetic word converter, determines what user option has been set, provides at least one phonetic word among the received phonetic words to a user when a user option of providing at least one phonetic word among the received phonetic words to the user has been set, receives a selection signal for selecting a phonetic word from the user, selects a phonetic word corresponding to the selection signal, converts the selected phonetic word into a phonetic string, and outputs the phonetic string to the lexicon.

The multi-phonetic string selector includes an exception dictionary database, which stores the words that the user sets as being difficult to be regularized for generation of phonetic strings.

According to another aspect of the present invention, there is provided a method of updating a lexicon. The method includes (a) receiving a word in the form of text data and generating a plurality of phonetic strings corresponding to the word; (b) converting the plurality of phonetic strings into phonetic words, respectively; (c) determining a user option that was set by a user in advance; (d) providing at least one phonetic word among the converted phonetic words to the user according to the result of determining the user option; and (e) receiving a selection signal for selecting a phonetic word from the user, selecting a phonetic word corresponding to the selection signal, converting the selected phonetic word into a phonetic string, and outputting the phonetic string to the lexicon.

Before step (a), the method further includes constructing an exception dictionary database, which stores words that the user sets as being difficult to be regularized for generation of phonetic strings.

### BRIEF DESCRIPTION OF THE DRAWINGS

The above aspects and advantages of the present invention will become more apparent by describing in detail preferred embodiments thereof with reference to the attached drawings in which:

FIG. 1 is a block diagram of an embodiment of a voice recognition apparatus including a lexicon updating apparatus according to the present invention;

FIG. 2 is a block diagram of an embodiment of a lexicon updating apparatus according to the present invention; and

FIG. 3 is a flowchart of a method of updating a lexicon according to an embodiment of the present invention.

### DETAILED DESCRIPTION OF THE INVENTION

Hereinafter, preferred embodiments of the present invention will be described in detail with reference to the attached drawings. Terms used in the present specification and claims should be construed as having meanings and embodying concepts conforming to the technological ideas of the present invention, based on the principle that inventors can appropriately define the concept of terms to optimally explain the invention.

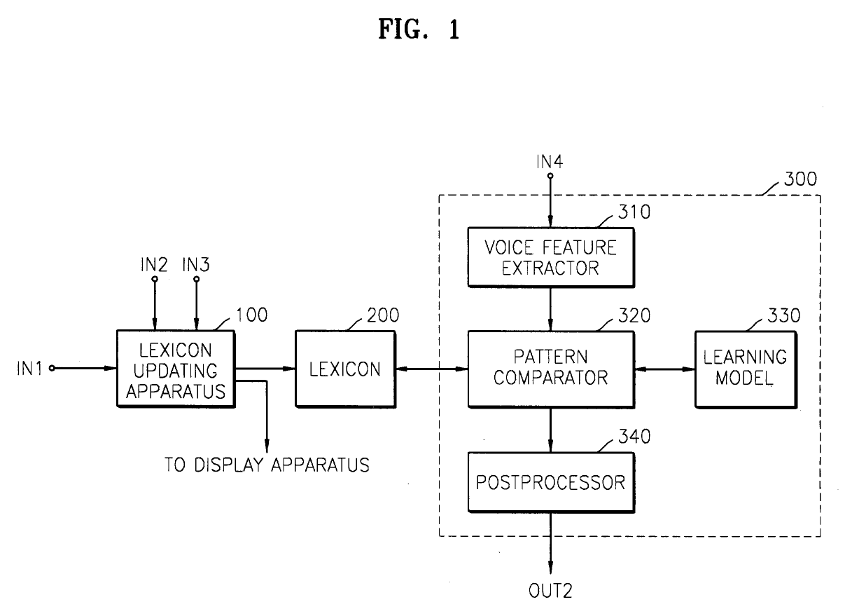

FIG. 1 is a block diagram of an embodiment of a voice recognition apparatus including a lexicon updating apparatus according to the present invention. The voice recognition apparatus includes a lexicon updating apparatus 100, a lexicon 200, and a voice recognition unit 300. The voice recognition unit 300 includes a voice feature extractor 310, a pattern comparator 320, a learning model 330, and a postprocessor 340.

The lexicon updating apparatus 100 receives a word in the form of text data, which is to be added to the lexicon 200 and recognized by a voice, from a user through an input terminal IN1. Subsequently, the lexicon updating apparatus 100 generates a plurality of phonetic strings corresponding to the input word according to a predetermined phonetic string generation rule and converts each of the phonetic strings into a corresponding phonetic word. The lexicon updating apparatus 100 includes a user option function to allow a user to set one among a plurality of options through an input terminal IN2 so that the user can select or input a phonetic string to be stored in the lexicon 200. The lexicon updating apparatus 100 receives a signal for selecting or inputting a phonetic string to be stored in the lexicon 200 through an input terminal IN3 from a user and outputs the phonetic string and the word input through the input terminal IN1 corresponding to the phonetic string to the lexicon 200.

The lexicon 200 stores the word received from the lexicon updating apparatus 100 to be added and at least one phonetic string corresponding to the word to be matched with each other. The following table shows an embodiment of the structure of the lexicon 200.

| Word | Phonetic string | Phonetic word |
|---|---|---|
| [symbol] | sil g a yo N_N sil | [symbol] |
| [symbol] | sil ga a m s u s \hat{ }ng | [symbol] |
| | sil | |
| | sil ga a m s u SS \hat{ }ng | [symbol] |
| | sil | |
| [symbol] | sil H a k gg yo sil | [symbol] |
| | sil H a gg yo sil | [symbol] |

In the above table, a phonetic string represents the pronunciation of a corresponding word and is stored in the lexicon 200. A phonetic string is composed of phoneme like units (PLUs). Data between symbols “sil” forms a single phonetic string. A transcription rule for phonetic strings may be different depending on a company manufacturing the lexicon 200. Here, a phonetic word is defined as a transcription of a phonetic string into Korean letters. The phonetic word just shows how the phonetic string is pronounced and is not stored in the lexicon 200.

It will be understood by those skilled in the art that while Korean-language words are used as examples in the description of the invention, Applicant's invention may be used in a speech recognition system for any natural language, including English.

A voice to be recognized is input through an input unit (not shown) such as a microphone and through an input terminal IN4 into the voice feature extractor 310 of the voice recognition unit 300. The voice feature extractor 310 performs a voice signal preprocessing operation, such as Fast Fourier Transform (FFT), on input voice data and then performs a voice feature extraction algorithm, such as Linear Predictive Coding (LPC) or Mel-Frequency Cepstral Coefficient (MFCC), to extract voice features from the input voice data. These search algorithms and learning models used as part of the recognition process and the voice extractor, and other processing steps used will be well-known to those skilled in the art. They are provided as examples, but Applicant's invention may be practiced irrespective of the particular algorithms, models, pre-processing and post-processing steps used as part of the voice processing, speech recognition and storage process.

The pattern comparator 320 receives the voice features from the voice feature extractor 310 and compares the patterns of voice signals using a statistical method referring to the lexicon 200 and the learning model 330 in order to recognize the input voice. A recognition process is performed in units of PLUs. A Viterbi search algorithm can be used as a pattern comparison algorithm, and a Hidden Marcov Model (HMM) can be representatively used as the learning model 330.

The postprocessor 340 serves to increase recognition speed and accuracy. For example, the postprocessor 340 uses a natural language method to check whether recognized words are normally used or has a grammar function of checking whether there is an obvious grammatical error.

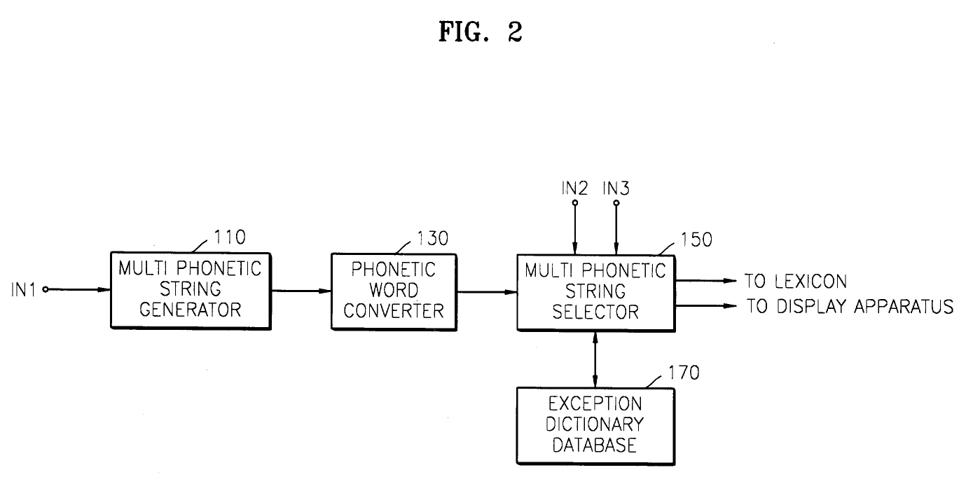

FIG. 2 is a block diagram of an embodiment of a lexicon updating apparatus according to the present invention. The lexicon updating apparatus includes a multi-phonetic string generator 110, a phonetic word converter 130, a multi-phonetic string selector 150, and an exception dictionary database 170.

A user inputs a word to be added to the lexicon 200 (shown in FIG. 1) in the form of text data to the multi-phonetic string generator 110 through an input terminal IN1. The multi-phonetic string generator 110 receives the word in the form of text data and generates and outputs a plurality of phonetic strings corresponding to the word according to a predetermined phonetic string generation rule. For example, if a Korean word “ [symbol] ” is input, phonetic strings such as [g a m s u s \hat{ } ng] and [g a m s u SS \hat{ } ng] are generated.

The phonetic word converter 130 receives the plurality of phonetic strings generated by the multi-phonetic string generator 110, converts the phonetic strings into phonetic words in order to provide the user through a display apparatus (not shown) such as a monitor, and outputs the phonetic words to the multi-phonetic string selector 150. For example, if the phonetic strings received from the multi-phonetic string generator 110 are [g a m s u s \hat{ } ng] and [g a m s u SS \hat{ } ng], phonetic words corresponding to the phonetic strings are [ [symbol] ] and [ [symbol] ].

The multi-phonetic string selector 150 allows the user to select phonetic strings to be stored in the lexicon 200. In other words, the multi-phonetic string selector 150 has a user option function so that the user can set a user option through an input terminal IN2 in advance to control the operation of the multi-phonetic string selector 150.

In an embodiment of the present invention, four types of options can be set. If a first option is set, all of the plurality of phonetic words input into the multi-phonetic string selector 150 are unconditionally provided to the user through the display apparatus, and the user selects a phonetic word corresponding to a phonetic string to be stored in the lexicon 200 through an input terminal IN3.

If a second option is set, then the plurality of phonetic words input into the multi-phonetic string selector 150 are provided to the user through the display apparatus only when the word input into the multi-phonetic string generator 110 is the same as a word that the user decided in advance as being difficult to be regularized for the generation of phonetic strings and stored in the exception dictionary database 170. Then, the user selects a phonetic word corresponding to a phonetic string to be stored in the lexicon 200 through the input terminal IN3. Words that are difficult to be regularized for generation of phonetic strings and thus stored in the exception dictionary database 170, may be words ending with Chinese letters corresponding to Korean letters “ [symbol] ” and “ [symbol] ”. For example, a Korean word “ [symbol] ” can be pronounced with [ [symbol] ], [ [symbol] ], or [ [symbol] ], so it is difficult to set a rule for generating phonetic strings.

If a third option is set, the user directly inputs a phonetic word corresponding to the word input into the multi-phonetic string generator 110. For example, when a pronunciation is transformed due to a provincial accent, the multi-phonetic string generator 110 has difficulty in automatically generating phonetic strings according to the predetermined phonetic string generation rule, so the user can directly input a phonetic word considering his/her own pronunciation habit. Then, the phonetic word input by the user is converted into a phonetic string, and the phonetic word and the phonetic string are stored together in the lexicon 200.

If a fourth option is set, the generated phonetic words are automatically stored in the lexicon 200 without the user's selection or input of a phonetic word.

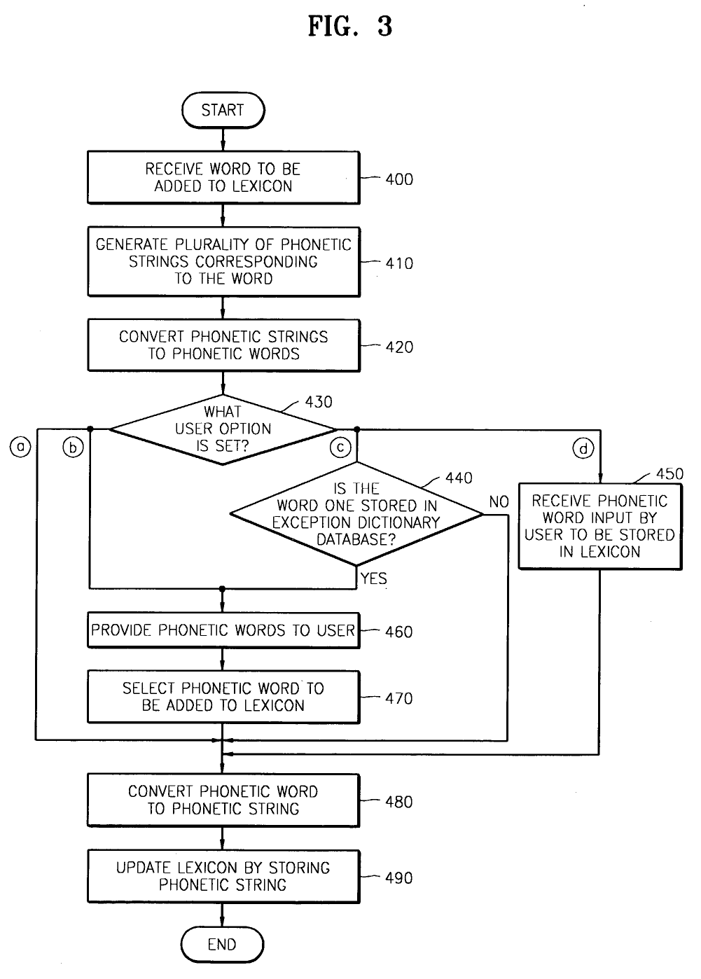

FIG. 3 is a flowchart of a method of updating a lexicon according to an embodiment of the present invention. Hereinafter, a method of updating a lexicon will be described with reference to FIGS. 2 and 3.

The multi-phonetic string generator 110 receives a word to be added to the lexicon in the form of text data from a user through the input terminal IN1 in step 400. The multi-phonetic string generator 110 generates a plurality of phonetic strings corresponding to the input word according to a predetermined phonetic string generation rule in step 410. The phonetic word converter 130 receives the phonetic strings from the multi-phonetic string generator 110, converts the phonetic strings into corresponding phonetic words, and outputs the phonetic words to the multi-phonetic string selector 150 in step 420.

The multi-phonetic string selector 150 receives the phonetic words from the phonetic word converter 130 and determines what user option is set in step 430. One among the four types of options described above can be set. A path \mathring{b} indicates the first option, a path \mathring{c} indicates the second option, a path \mathring{d} indicates the third option, and a path \mathring{a} indicates the fourth option.

When the user sets the first option, i.e., the path \mathring{b}, the multi-phonetic string selector 150 provides all of the received phonetic words to the user through a display apparatus in step 460. The user selects a phonetic word corresponding to a phonetic string to be stored in the lexicon through the input terminal IN3 of the multi-phonetic string selector 150 in step 470.

After step 470, the multi-phonetic string selector 150 converts the selected phonetic word into the corresponding phonetic string and outputs the phonetic string to the lexicon in step 480 because not a phonetic word but a phonetic string is stored in the lexicon. After step 480, the word and the plurality of phonetic strings corresponding to the word are input from the multi-phonetic string selector 150 into the lexicon and stored in the lexicon to update the lexicon in step 490.

If the second option is set, i.e., the path \mathring{c}, the multi-phonetic string selector 150 determines whether the word is one that stored in the exception dictionary database 170 in step 440. If the word is stored in the exception dictionary database 170, step 460 through 490 are performed.

If the third option is set, i.e., the path \hat{d}, the user directly inputs a phonetic word corresponding to the word through the input terminal IN3 in step 450. Then, steps 480 and 490 are performed.

If the third option is set, i.e., the path \mathring{a}, steps 480 and 490 are performed. In other words, the phonetic words generated by the phonetic word converter 130 are stored in the lexicon to update the lexicon.

The present invention can be realized as code recorded on a computer-readable recording medium read by a computer or data processor. The computer-readable recording medium may be any type on which data which can be read by a computer system can be recorded, for example, a ROM, a RAM, a CD-ROM, a DVD, a magnetic tape, a floppy disc, a control card, a circuit board, eprom, firmware, hardware, or an optical data storage device. The present invention can also be realized as carrier waves (for example, transmitted through Internet). Alternatively, computer-readable recording media are distributed among computer systems connected through a network so that the present invention can be realized as code stored in the recording media and can be read and executed in or by the computers or any type of data processors.

As described above, the present invention prevents unnecessary phonetic strings from being generated, thereby increasing recognition speed. Since the present invention allows a pronunciation of, for example, dialect or a word of foreign language, which is difficult to be generated according to a rule, to be added to a lexicon, recognition performance can be increased. In addition, the present invention displays phonetic words to a user, so that the user can visually check how a word must be pronounced in order to be well recognized, thereby increasing recognition success rate.

What is claimed is:

1. An apparatus for updating a lexicon, comprising:
a multi-phonetic string generator configured to receive a word in the form of text data and to generate a plurality of phonetic strings corresponding to the word;
a phonetic word converter configured to receive the generated plurality of phonetic strings and to convert each generated phonetic string of the generated plurality of phonetic strings into a respective phonetic word; and
a multi-phonetic string selector configured to receive the converted phonetic words from the phonetic word converter, to provide to a user at least one converted phonetic word of the converted phonetic words, to receive from the user a selection signal selecting a phonetic word, to select the selected phonetic word corresponding to the selection signal, to convert the selected phonetic word into a selection phonetic string, and to output the selection phonetic string to the lexicon.

2. The apparatus of claim 1, wherein the multi-phonetic string selector provides all of the converted phonetic words corresponding to the word.

3. The apparatus of claim 1, wherein the multi-phonetic string selector stores words that the user sets as being difficult to be regularized for generation of phonetic strings and provides to the user the converted phonetic words only when the received word is one of the stored words.

4. A method of updating a lexicon, comprising:
(a) receiving a word in the form of text data and generating a plurality of phonetic strings corresponding to the word;
(b) converting each string of the plurality of phonetic strings into a respective phonetic word;
(c) providing to a user at least one converted phonetic word of the converted phonetic words; and
(d) receiving from the user a selection signal to select a phonetic word, selecting a selected phonetic word corresponding to the selection signal, converting the selected phonetic word into a selection phonetic string, and outputting the selection phonetic string to the lexicon.

5. The method of claim 4, wherein all of the converted phonetic words converted through the conversion in operation (b) corresponding to the word input in operation (a) are provided to the user.

6. The method of claim 4, further comprising before operation (a), operation (e) comprising storing at least one word that the user sets as being difficult to be regularized for generation of phonetic strings, wherein the converted phonetic words are provided to the user only when the word input in step (a) is one of the words set in step (e).

7. An apparatus for updating a lexicon, comprising:
a multi-phonetic string generator configured to receive a word in the form of text data and to generate a plurality of phonetic strings corresponding to the word;
a phonetic word converter configured to receive the generated plurality of phonetic strings and to convert each string of the generated plurality of phonetic strings into a respective phonetic word; and
a multi-phonetic string selector configured to receive the converted phonetic words from the phonetic word converter, to determine what user option has been set, to provide to a user, when a user option has been set to provide at least one converted phonetic word, at least one converted phonetic word, to receive from the user a selection signal selecting a selected phonetic word, to select the selected phonetic word corresponding to the selection signal, to convert the selected phonetic word into a selection phonetic string, and to output the selection phonetic string to the lexicon.

8. The apparatus of claim 7, wherein the user option is set to provide to the user all of the converted phonetic words input from the phonetic word converter into the multi-phonetic string selector.

9. The apparatus of claim 7, wherein the multi-phonetic string selector comprises an exception dictionary database configured to store at least one word that the user sets as being difficult to be regularized for generation of phonetic strings.

10. The apparatus of claim 9, wherein the user option is set to provide to the user the converted phonetic words input from the phonetic word converter into the multi-phonetic string selector only when the received word is stored in the exception dictionary database.

11. The apparatus of claim 7, wherein the user option is set to convert all of the converted phonetic words input from the phonetic word converter into the multi-phonetic string selector into phonetic strings and to output the converted phonetic strings to the lexicon.

12. The apparatus of claim 7, wherein the user option is set such that the user directly inputs a phonetic word corresponding to the received word into the multi-phonetic string selector.

13. A method of updating a lexicon, comprising:
(a) receiving a word in the form of text data and generating a plurality of phonetic strings corresponding to the word;
(b) converting each string of the converted plurality of phonetic strings into a respective phonetic word;
(c) determining a user option set in advance by a user;
(d) providing to the user converted phonetic words, according to a result of the determining the user option set; and
(e) receiving from the user a selection signal selecting a selected phonetic word, converting the selected phonetic word into a selection phonetic string, and outputting the selection phonetic string to the lexicon.

14. The method of claim 13, wherein all of the converted phonetic words converted through the conversion in step (b) are provided to the user, according to the result of the determining the user option set.

15. The method of claim 13 further comprising before operation (a), operation (f) comprising constructing an exception dictionary database configured to store words set by the user as being difficult to be regularized for generation of phonetic strings.

16. The method of claim 15, wherein according to the result of determining the user option, the phonetic words converted through the conversion in step (b) are provided to the user only when the received word is stored in the exception dictionary database.

17. The method of claim 13, wherein according the result of the determining the user option, all of the converted phonetic words converted through the conversion in step (b) are converted into phonetic strings, and the converted phonetic strings are provided to the user.

18. The method of claim 13, wherein according to the result of the determining the user option, the user is allowed to input directly a corresponding phonetic word corresponding to the received word.

19. A computer-readable recording medium incorporating a program to execute a method of updating a lexicon, the method comprising:
receiving a word in the form of text data and generating a plurality of phonetic strings corresponding to the word;
converting each string of the generated plurality of phonetic strings into a respective phonetic word;
providing to a user at least one phonetic word of the converted phonetic words; and
receiving from the user a selection signal to select a selection phonetic word, selecting the selection phonetic word corresponding to the selection signal, converting the selection phonetic word into a selection phonetic string, and outputting the selection phonetic string to the lexicon.
